(19) United States
(12) Patent Application Publication
(10) Pub. No.: US 2010/0119424 A1
(43) Pub. Date: May 13, 2010

(54) CATALYST

(76) Inventors: Fredrik Almqvist, Umea (SE); Basudeb Basu, Darjeeling (IN)

Correspondence Address: Lynn E. Barber, Post Office Box 16528, Fort Worth, TX, 76162, US

(21) Appl. No.: 12/451,432

(22) PCT Filed: May 14, 2008
(86) PCT No.: PCT/EP2008/055866

§ 371 Date: Nov. 12, 2009

(30) Foreign Application Priority Data
May 14, 2007 (EP) 07009638.3

(51) Int. Cl. B01J 19/00; B01J 37/30

(52) U.S. Cl. 422/211; 502/11

(57) ABSTRACT

The present invention relates to a method of producing a heterogeneous catalyst suitable for catalyzing Heck, Suzuki-Miyaura Sonogashira coupling and Buchwald-Hartwig reactions, comprising the steps of: a) providing a macroporous carrier, said macroporous carrier consisting of a core and a plurality of ion exchange groups covalently bonded to the surface of said core, where at least 90% of the ions bound to said carrier are formate ions; b) swelling said carrier in a polar solvent; c) providing a palladium (II) salt; d) suspending said carrier in an organic solvent thereby obtaining a suspension; e) adding said palladium salt to said suspension and allowing the resulting mixture to react at a temperature within the range of 0 70° C. until said carrier has turned black; f) washing said carrier in water; g) drying said carrier under vacuum.

### TECHNICAL BACKGROUND

Transition metal-catalyzed organic reactions constitute the central part of contemporary organic synthesis. In particular, palladium-catalyzed carbon-carbon and carbon-heteroatom (N and O) bond-forming processes represent the foremost reactions in the arena of organic process development. All documents cited in this description are incorporated by reference unless nothing else is stated. While the Heck, Sonogashira coupling and Suzuki-Miyaura reactions are excellent tools for carbon-carbon coupling reactions between aryl halides or triflates and suitable partners, Buchwald-Hartwig developed the expeditious means for carbon-heteroatom (N and O) bond-forming reactions. Over the last decade, commendable research has been done to achieve significant developments and to establish practical methodologies. Widespread uses of the palladium-catalyzed coupling reactions are found in modem organic synthesis, because the resulting coupled products often find good applications in the preparation of materials and drugs.

Since the common facet of these homo- and hetero-coupling reactions is the palladium, which is believed to act as the catalyst, numerous attempts have been made to employ it either as soluble homogeneous. Whereas the soluble homogeneous Pd-catalysts are found to be significantly active in various coupling reactions, there are some drawbacks such as, less active or inactive colloidal species, unrecoverable and possibility of contamination with the products, cost etc. that are often encountered in the course of the reactions. Consequently, several approaches have been explored utilizing various immobilization techniques on solid or colloidal supports, and aiming toward efficient recovery and reuse of the active catalysts. The major thrust for achieving success in designing and developing polymer-supported metal catalysts broadly include: improved stability within the polymer matrix, increased selectivity for reactions, enhanced regioselectivity, reusability for several runs and superior asymmetric induction due to site-specific chiral catalysts. Attempts have been made to surmount the problems pertaining to high reaction temperatures, separation of pure products, recovery and reuse of Pd-complexes by the use of heterogeneous palladium systems. Pd on carbon and Pd on different metal oxides were found to be suitable catalysts for some reactions. Several groups have examined use of polymer/dendrimer supported Pd-catalysts, where the immobilization of palladium has been achieved through covalent and non-covalent linkages and using coordinating phosphine ligands attached to the polymeric framework. There has been significant interest in the use of supported nanopalladium complexes as catalysts for C—C coupling reactions. More recently, heterogeneous Pd-catalysts have been developed through microencapsulation technology, optionally with activating ligands, within a highly cross-linked polyurea matrix. Advantages of such polymer-supported Pd-catalysts are focused with emphasis on several factors e.g. very low residual metal and ligand level in final products, easy of recovery by filtration, re-use and recycling, high activity, selectivity and compatibility. While some of these supported catalysts exhibit excellent activity and selectivity in various reactions, most of them suffer from general compliance with all the conditions and often require difficultly accessible and well-designed polymeric frameworks. Therefore, procedural complexity and versatile applicability have remained seemingly important and major thrust for further investigations in this field of research.

Recently, (B. Basu, S. Das, P. Das, A. K. Nanda, Tetrahedron Lett. 2005, 46, 8591-8593) reported the first heterogeneous Pd-catalyst, immobilized as Pd⁽⁰⁾ on a surface of ion-exchange resins. The reaction is a reduction reaction and only focus on the use of gel type carriers. The Amberlite® resins, IRA® 420, gel type, (chloride form) was first exchanged with formate anion to prepare the Amberlite resin formate (symbolized as ARF), washed with water and dried, which was then treated with catalytic amounts of Pd(OAc)₂ in dimethyl formamide (DMF) under nitrogen. The Pd^{(II)} species was soon found to be reduced to Pd⁽⁰⁾ in presence of formate anion as the counter anion of the Amberlite resins. The greyish beads of ARF were turned black, probably with the deposition of Pd⁽⁰⁾ on the resin surface. Since the resulting Amberlite resin formate soaked palladium complexes possess both the reducing source in presence of suitable metal catalyst (here the formate anion and the palladium), the article envisaged use of these complexes in catalytic transfer hydrogenation. Indeed, the complexes showed good efficiency in catalytic transfer hydrogenation of functionalized C—C or C-heteroatom (N and O) double bonds. This catalyst works really good when it comes to hydrogenation. However, this catalyst did not work as supposed when it came to heterogeneous C—C and C—N coupling, only a very small yield was seen.

However, it was also clear that the complexes were not sufficiently stable and that there was an unacceptably high uncontrolled leakage of both high active palladium and non active palladium from the beads. Accordingly, there is a need for an improved catalyst, where the problems regarding stability and leakage have been solved. Specifically it has been established that the leakage of high active palladium must be low and controlled in order to reach a commercially and economically method of producing a heterogeneous catalyst suitable for catalyzing Heck, Suzuki-Miyaura, Sonogashira coupling and Buchwald-Hartwig reactions. The leaching of non active palladium has to be kept at a absolute minimum.

### SUMMARY OF THE INVENTION

In a first aspect, the present invention provides a method of producing an improved heterogeneous catalyst suitable for catalysing Heck, Suzuki-Miyaura, Sonogashira coupling and Buchwald- Hartwig reactions, where the above mentioned problems have been solved. Said method is disclosed by the following steps:

A method of producing a heterogeneous catalyst suitable for catalyzing Heck, Suzuki-Miyaura, Sonogashira coupling and Buchwald-Hartwig reactions, comprising the steps of

a) providing a macroporous carrier, said macroporous carrier consisting of a core and a plurality of ion exchange groups covalently bonded to the surface of said core, where at least 90% of the ions bound to said carrier are formate ions;

b) swelling said carrier in a polar solvent;

c) providing a palladium (II) salt;

d) suspending said carrier in an organic solvent thereby obtaining a suspension;

e) adding said palladium salt to said suspension and allowing the resulting mixture to react at a temperature within the range of 0-70° C. until said carrier has turned black;

f) washing said carrier in water; and

g) drying said carrier under vacuum.

The inventors have unexpectedly found that by introducing a swelling step b) before providing the palladium and also the use of carriers of macroporous type such as Amberlite IRA 900 Cl they were able to control the leakage of high active palladium and producing an improved heterogeneous catalyst suitable for catalysing the reactions above. The swelling of a carrier in a polar solvent such as methanol, ethanol, etc., preferably methanol achieves greater porosity.

Without wishing to be bound by any theory the inventors suspect that it could be an unexpected synergistic effect in the new method when using a swelling step and Amberlite IRA 900 Cl, however, Amberlite IRA 900 Cl seems to play the most important role.

The use of sodium formate instead of formic acid speeds up the exchange of the chloride ion. A factor 6 has been observed. The speed of the ion exchange reaction could be improved significantly if Off resin is used, but the macropourosity of the Amberlite IRA 900 Cl still seems to play the most important role. The time could be reduced from days to hours. Increasing the commercial value of the new method tremendously.

The inventors have shown that by using the new macroporous resins method disclosed in the present invention the leakage can be controlled and maintained at a stable level resulting in leakage of high active palladium from the beads.

By introducing a cooling in step (e) after the carrier has been suspended step (d) i.e. at the same time when adding the palladium salt step (e) improved catalytic features such as a prolonged leakage time could most likely be observed, i.e. leading to a potential higher palladium loading and therefore a catalyst that has the potential to be more long-lasting. The cooling step could most likely result in a slower reduction and the palladium salt penetrates deeper into the resin. Step (e) could be performed starting with a temperature of -78° C. and then slowly the temperature is increased until said carrier has turned black.

The reaction in the new method is a coupling reaction and not a reduction reaction frequently used in the prior art.

420 The inventors have unexpected found that resins of gel types such as Amberlyst 420 does not produce high active palladium with sufficient yield. Especially it was noticed that an unacceptably high uncontrolled leakage of both high active palladium and non active palladium from the beads. Macroporous resins provides high active palladium with sufficient yield.

Further, it was unexpected that resins with size less than 420 μm did not work as good as larger sized, especially since the small size is expected to provide increased surface area per g resin. By using large sized resins such as Amberlite 900, size about 500 μm, an improved catalytic effect has been shown in comparison to the small. Another advantage of using the larger sized resins is that the handling process is improved. However, the size of the resins does most likely not effect the yield as much as the use of macromacroporous type resins such as Amberlite IRA 900 Cl.

Accordingly, the method involves using a porous carrier, said porous carrier consisting of a core and a plurality of ion exchange groups covalently bonded to the surface of said core, where at least 90% of the ions that are bound to the beads are formate ions. Preferably, at least 95% of the ions bound to the beads are formate ions. Most preferably, at least 99% of the ions that are bound to the beads are formate ions.

Typically, the carrier could have the shape of a spherical particle. It could also typically have a size ranging from 10 μm to 2 mm and a porosity from 50 to 1000 Å. Other ranges could be 100 μm to 2 mm, 300 μm to 2 mm, 500 μm to 2 mm, 700 μm to 2 mm. Alternatively, the carrier could have a monolithic structure. The core of the carrier is typically made of a material chosen from the group of porous silica, zirconium, graphite, or a polymer or copolymer chosen from the group of mono- or oligovinyl monomer units, such as styrene and its substituted derivatives, acrylic acid or methacrylic acid, alkyl acrylates and methacrylates, hydroxyalkyl acrylates and methacrylates, acrylamides and methacrylamides, vinylpyridine and its substituted derivatives, divinylbenzene, divinylpyridine, alkylene diacrylate, alkylene dimethacrylate, oligoethylene glycol diacrylate and oligoethylene glycol dimethacrylate with up to 5 ethylene glycol repeat units, alkylene bis(acrylamides), piperidine bis(acrylamide), trimethylolpropane triacrylate, trimethylolpropane trimethacrylate, pentaerythriol triacrylate and tetraacrylate, and mixtures thereof.

As mentioned above, ion-exchange groups have been introduced on the surface of said carrier core by functionalizing via a chemical reaction. In another embodiment, the ion-exchange groups have been introduced to the carrier by polymerisation, preferably graft polymerisation onto the surface of said carrier core. Preferably, the ion exchange groups are type 1 or type 2 quaternary ammonium groups.

It is especially preferred that the carrier is a macroporous bead such as Amberlite IRA-900 (Acros, B E) with a size about 16-50 mesh, 1.2-0.3 mm.

Furthermore, the method involves using a palladium (II) salt. In principle, any palladium (II) salt could be used in the method. Palladium acetate (Pd(CH₃COO)₂) and disodium palladium tetrachloride (Na₂PdCl₄) are preferred.

Said beads are suspended in an organic solvent. Most organic solvents could be used. Preferably, the organic solvent is chosen from the group of dimethyl formamide (DMF), acetonitrile, toluene and dioxane. Dimethyl formamide is especially preferred. Said palladium salt is then added to said suspension and the resulting mixture is allowed to react at a temperature within the range of 0-70° C., and preferably within the range of 40-60° C. A temperature within the range of 45-55° C. is especially preferred. The reaction is deemed to be completed when said beads have turned black. The black colour is associated with deposition of Pd(0). The beads are washed in water and dried under vacuum.

In a preferred embodiment, carriers such as Amberlite beads to which formate ions have been bound can be prepared by exposing the chloride form of Amberlite resin, such as Amberlite IRA-900 (Acros, B E) to formic acid or preferably sodium formate until release of chloride ions from the resin no longer can be observed.

In a second aspect, the present invention also provides a heterogeneous catalyst comprising a porous carrier consisting of a core and a plurality of ion exchange groups covalently bonded to the surface of said core, typically Amberlite IRA-900, on which surface Pd(0) as well as formate has been deposited. Said catalyst has been produced by a method according to the first aspect of the present invention. Below, said catalyst based on Amberlite IRA-900 is also referred to as New Pd Catalyst.

In a third aspect, the present invention provides a reactor comprising a hollow tube having two open ends, which reactor contains a heterogeneous catalyst according to said second aspect.

In a fourth aspect, the present invention relates to using said catalyst for catalysing Heck, Suzuki-Miyaura, Sonogashira coupling and Buchwald- Hartwig reactions.

### EXPERIMENTAL PART

The invention will now be described with reference to the enclosed examples and figures.

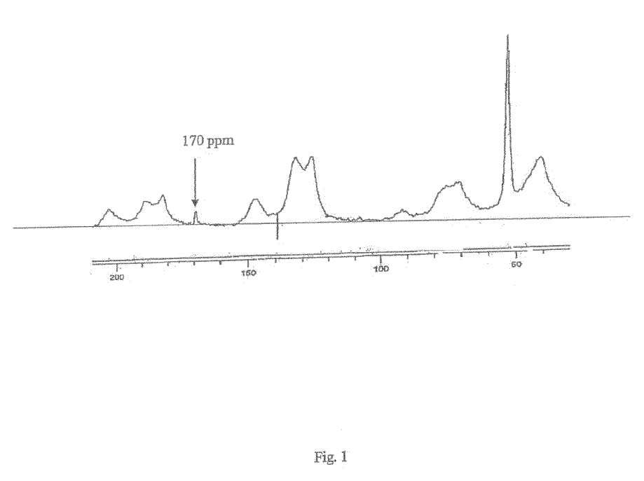

FIG. 1 presents a ¹³C MAS NMR of ARF.

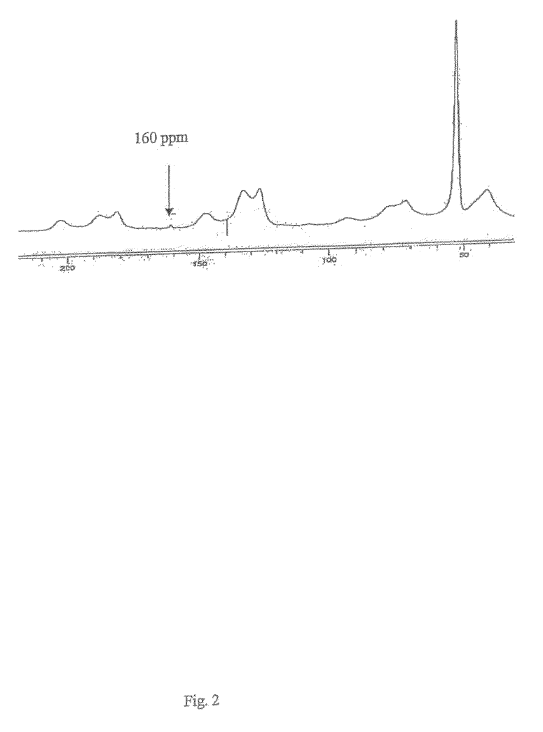

FIG. 2 shows a ¹³C MAS NMR of New Pd Catalyst.

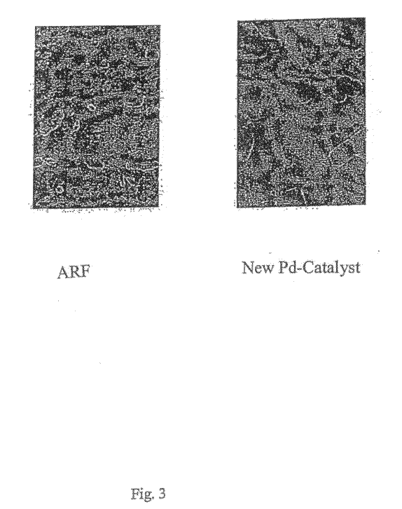

FIG. 3 displays SEM micrograph images (10000× magnified) of ARF and New Pd Catalyst.

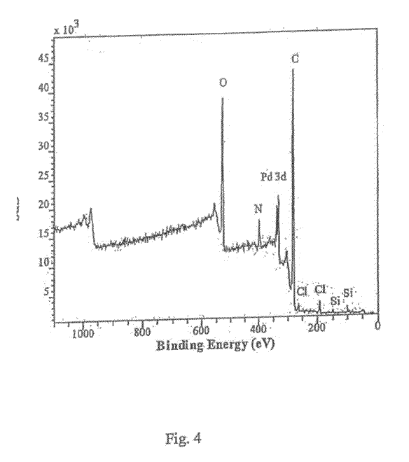

FIG. 4 discloses XPS survey spectrum and Pd 3d spectrum of the precatalyst New Pd Catalyst.

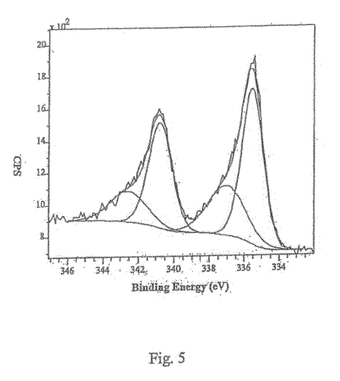

FIG. 5 reveals a Pd 3d spectrum of fresh New Pd Catalyst precatalyst prepared from Pd(OAc)₂.

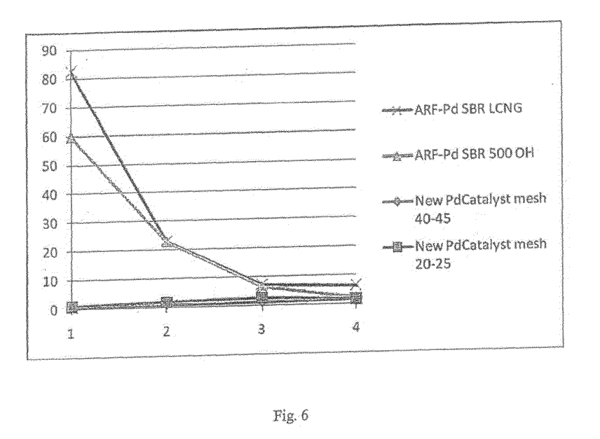

FIG. 6 shows the difference in leakage of palladium (mcg) as a function of catalytic cycles between ARF-Pd and the New Pd-Catalyst

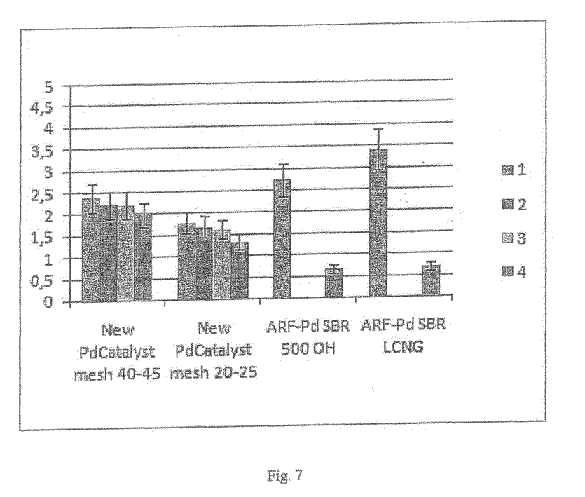

FIG. 7 shows the palladium content (mg) per resin (g) as a function of catalytic cycles.

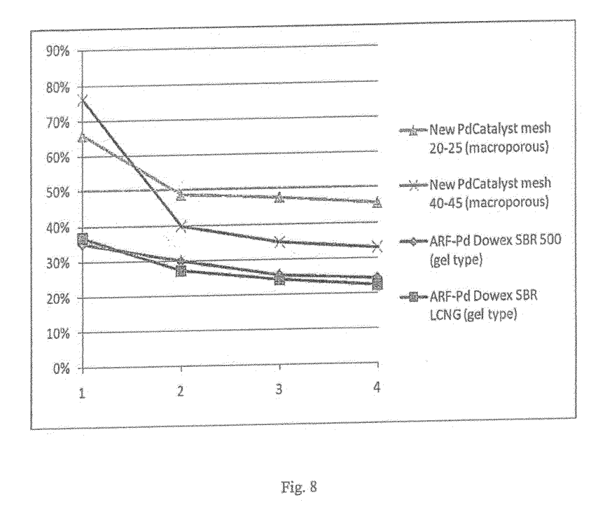

FIG. 8 shows the synthesis yield (%) as a function of catalytic cycles.

The examples should not be construed as limiting the scope of the appended claims.

### EXAMPLE 1

### Catalyst Preparation

Amberlite® IRA 900 (Chloride form) (Acros, B E) was packed in a column and treated with 0.5% sodium formate solution repeatedly until a negative response was observed for chloride ion. The resin was then washed with water until a low conductivity response was shown and dried under vacuum Palladium acetate (20 mg, 0.089 mmol) was added to a suspension of ARF (2 g) in DMF (4 ml) and the mixture was stirred under N₂ for 1 h at room temperature and then at 50° C. for 3 hr. The orange or dark orange color of the solution became totally colorless, whereas the ARF beads became black. Such color changes were not observed while using the Amberlite® IRA 900 (Chloride form) and Pd(OAc)₂ or Na₂PdCl₄ in control experiments, which led to suggest that Pd^{(II)} species were reduced to Pd⁽⁰⁾ in presence of the counter anion (formate as the reducing source) and then soaked on the resin surface. The grayish beads were turned black and the dark orange supernatant became totally colourless by this time. The mixture was cooled, filtered off the resin beads and washed with water until the washing was almost free from sodium (≦0.1 mg per liter of water; analyzed by flame photometer) (applicable when Na₂PdCl₄ was used). The black resins were then dried under vacuum (50° C./0.1 mm of Hg).

### EXAMPLE 2

### Catalyst Preparation Starting from Na₂PdCl₄

The method of example 1 was repeated but an equal molar amount of Na₂PdCl₄ was used instead of Pd(OAc)₂. A similar result was obtained.

Amberlite® IRA 900 (Chloride form) (Acros, B E) was packed in a column and treated with 0.5% sodium formate solution repeatedly until a negative response was observed for chloride ion. The resin was then washed with water until a low conductivity response was shown and dried under vacuum. The dried resins (2 g) were then taken in methanol and left for 2 h. Excess methanol were then removed and Palladium acetate (20 mg, 0.089 mmol) diluted in DMF (15 ml) were added and the mixture was stirred under N₂ for 1 h at room temperature and then at 50° C. for 3 hr. The orange or dark orange color of the solution became totally colorless, whereas the ARF beads became black. Such color changes were not observed while using the Amberlite® IRA 900 (Chloride form) and Pd(OAc)₂ or Na₂PdCl₄ in control experiments, which led to suggest that Pd^{(II)} species were reduced to Pd⁽⁰⁾ in presence of the counter anion (formate as the reducing source) and then soaked on the resin surface. The grayish beads were turned black and the dark orange supernatant became totally colourless by this time. The mixture was cooled, filtered off the resin beads and washed with water until the washing was almost free from sodium (≦0.1 mg per liter of water; analyzed by flame photometer) (applicable when Na₂PdCl₄ was used). The black resins were then dried under vacuum (50° C./0.1 mm of Hg).

Amberlite® IRA 900 (Chloride form) (Acros, B E) was packed in a column and treated with 0.5% sodium formate solution repeatedly until a negative response was observed for chloride ion. The resin was then washed with water until a low conductivity response was shown and dried under vacuum The dried resins (2 g) were then taken in methanol (4 ml) and left for 2 h. Excess methanol was then removed and DMF (4 ml) were added. The suspension was cooled down to −78° C. and a pre cooled solution of Pd(OAc)₂ (30 mg 0.134 mmol) in DMF (15 ml) were added. The mixture was left over night under gentle stirring to obtain room temperature. The orange or dark orange color of the solution became totally colorless, whereas the ARF beads became black. Such color changes were not observed while using the Amberlite® IRA 900 (Chloride form) and Pd(OAc)₂ or Na₂PdCl₄ in control experiments, which led to suggest that Pd^{(II)} species were reduced to Pd⁽⁰⁾ in presence of the counter anion (formate as the reducing source) and then soaked on the resin surface. The grayish beads were turned black and the dark orange supernatant became totally colourless by this time. The mixture was cooled, filtered off the resin beads and washed with water until the washing was almost free from sodium (≦0.1 mg per liter of water; analyzed by flame photometer) (applicable when Na₂PdCl₄ was used). The black resins were then dried under vacuum (50° C./0.1 mm of Hg).

### EXAMPLE 3

### FT-IR Spectroscopy of the New Pd Catalyst

The new Pd Catalyst was first characterized by IR spectroscopy. Carboxylic acid salts are most accurately represented with the resonance stabilized carboxylate anions that contain two identical C═O bonds, and therefore give anti-symmetric and symmetric stretching absorptions. The FT-IR spectral data for the carboxylate anion of different formate salts, ARF and the New Pd Catalyst are given in Table 1. The spectrum of New Pd Catalyst was compared with those of ammonium formate (HCOONH₄), potassium formate (HCOOK) and the ARF. The absorptions due to anti-symmetric stretching of the carboxylate anions of HCOONH₄, HCOOK and ARF were observed in the range of 1595-1593 cm⁻¹, while that of New Pd Catalyst at 1653 cm⁻¹. Similar observations were noticed in the case of symmetric stretching of the carboxylate anions. The significant increase of vₘₐₓ for New Pd Catalyst indicated possible deposition and binding of the palladium metal with the formate carbonyl species.

TABLE 1
FT-IR data for the carboxylate anion (KBr)

| | Symmetric | Anti-symmetric |
|---|---|---|
| | Stretching | Stretching |
| Entry | (ₘₐₓ) Cm⁻¹ | (ₘₐₓ) Cm⁻¹ |
| HCOONH₄ | 1354 | 1595 |
| HCOOK | 1348 | 1593 |
| ARF | 1344 | 1593 |
| New Pd Catalyst | 1404 | 1653 |

### EXAMPLE 4

### ¹³C MAS NMR Spectroscopy

The MAS ¹³C NMR spectra of ARF (FIG. 1) and New Pd Catalyst (FIG. 2) are recorded with special attention to the 8 position of the carbonyl carbon (formate). As compared to the formate carbonyl carbon of ARF, the same has shown nearly δ 10 ppm upfield shift for New Pd Catalyst. Thus, the carbonyl carbon in ARF appeared at about δ 170 ppm (FIG. 1) while that of New Pd Catalyst displayed nearly at δ 160 ppm (FIG. 2). Such upfield shifting in New Pd Catalyst may be attributed to binding of palladium with the formate carbonyl group.

### EXAMPLE 5

### Scanning Electron Micrographs

Scanning electron micrographs of ARF and New Pd Catalyst were examined at 1000× magnification using JEOL JSM 5700F scanning electron microscope. The SEM images (FIG. 3) illustrate clearly the differences in surface and shape characteristics and one might explain that palladium has been deposited in the surface of the resins.

### EXAMPLE 6

### XPS Studies

The presence of Pd in the surface was confirmed by XPS survey spectra (FIG. 4). Binding energy (BE) of Pd 3d line indicates that the main component of palladium is in the metallic form (335.7 eV), while the minor part may be assigned to Pd^{(II)} cation (337.8 eV). Two lines for Pd⁽⁰⁾ [335.7 eV (3d_{5/2}) and 340.8 (3d_{3/2}) eV], which are observed in the XPS spectrum of the New Pd Catalyst. Minor presence of Pd^{(II)} species might be possible from the fact that the Pd^{(II)} salts were not completely reduced during the preparation of ARF-Pd. Comparison of the spectra of New Pd Catalyst prepared from Pd(OAc)₂ (10 mg/g or 7.5 mg/g of the New Pd Catalyst) revealed similar observations and catalytic activity (FIG. 5).

### EXAMPLE 7

### Catalytic Activity: Heck Coupling Reaction

The catalytic activity of New Pd Catalyst was first examined in the Heck coupling reactions. As a first model case, the inventors chose the reaction of 3-chloroiodobenzene with ethyl acrylate. The Heck coupling between these two coupling partners is known to give high yields of the coupled product in presence of both homogeneous and other heterogeneous palladium catalysts. Using our heterogeneous catalyst, New Pd Catalyst, and carrying out the reaction in presence of triethylamine and toluene, the inventors were able to isolate trans-ethyl-3-chlorocinnamate in 86% yield. The trans-stereochemistry of the double bond was assigned on the basis of the value of the coupling constant (J=15.9 Hz). The inventors did not see any other products in this reaction when characterized by NMR. The product was isolated in pure form simply by filtering off the resin-bound catalyst followed by chromatographic purification of the concentrated residue. Similar reactions were conducted with other substituted iodoarenes and the results are summarized in Table 2. In each case, the NMR spectra indicated trans double bonds of 2-aryl acrylates, the J values range from 15.6-16.2 Hz. Interestingly, the bromo-substituent remained unchanged, which is typically seen for other halogens like chloro or fluoro groups on the aromatic moiety, thereby allowing more selectivity in Heck coupling reaction. The ortho-substituent did not cause any steric inhibition, as usually experienced in other coupling reaction, which may be attributed to high activity of the catalyst. In the case of 3-iodobenzene, both the mono- and bis-coupled products were isolated in the ratio of 1:2, when performed the reaction at 100° C. for 7 h.

Representative Procedure for Heck Reaction: To a suspension of New Pd Catalyst (300 mg, 2 mol % Pd) in toluene (2 mL) were added 4-bromo-1-iodo anisole (313 mg, 1 mmol), ethyl acrylate (220 mg, 2.2 mmol), triethyl amine (202 mg, 2 mmol) and the reaction mixture was heated under N₂ with gentle magnetic stirring at 90° C. for 10 h. The reaction mixture was passed through a cotton bed to isolate the catalyst and washed it with dichloromethane. The combined washings were concentrated under reduced pressure leaving a residue, which was purified by column chromatography on silica gel. Elution with ethyl acetate/light petroleum (1:10) afforded ethyl-3-(5-bromo-2-methoxyphenyl)acrylate as color less solid (256 mg, 90% yield); m.p.63-64° C.; IR (Nujol): vₘₐₓ 1713, 1632, 1589 cm⁻¹; ¹H NMR (300 MHz, CDCl₃, 300K): δ=7.87 (d, 1H, J=16.2 Hz); 7.59 (d, 1H, J=2.4 Hz); 7.40 (dd, 2H, J=8.7 & 2.4 Hz); 6.77 (d, 1H, J=9 Hz); 6.48 (d, 1H, J=16.2 Hz), 4.26 (q, 2H, J=7.2 Hz); 3.85 (s, 3H); 1.33 (t, 3H, J=7.2). ¹³C NMR (75 MHz, CDCl₃, 300K): δ=166.9, 157.1, 138.2, 133.6, 131.0, 125.3, 119.8, 113.1, 112.8, 60.8, 55.6, 14.2.

TABLE 2
Heck Coupling of aryl iodides with ethyl acrylate using New Pd-Catalyst.

| | | Conditions^{[a]} | | | |
|---|---|---|---|---|---|
| Entry | Haloaromatics | Temp./Time | Product(s) | Yield [%]^{[b]} | |
| 1 | 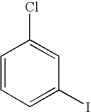 | 90° C./5h | 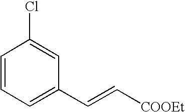 | 86 | |
| 2 | 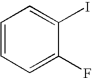 | 90° C./5h | 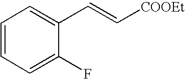 | 81 | |
| 3 | 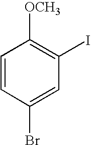 | 90° C./10h | 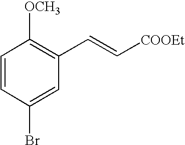 | 90 | |
| 4 | 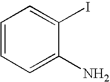 | 95° C./9h | 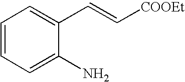 | 73 | |
| 5 | 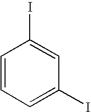 | 100° C./7h | 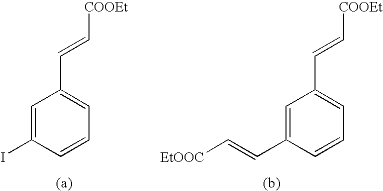 | 30 (a) | 65 (b) |

^{[a]}The reactions were carried out in toluene as the solvent; New Pd-Catalyst was used 300 mg per mmol of the bromoarene.
^{[b]}Yields are of isolated pure compounds, characterizad by IR and NMR spectral data.

### EXAMPLE 8

### Suzuki-Miyaura Coupling Reaction

The Suzuki-Miyaura coupling reaction between bromoarenes and aryl boronic acid is considered as one of the most important methods for preparing biaryls Suzuki-Miyaura coupling is discussed in S. Kotha, K. Lahiri, D. Kashinath, Tetrahedron 2003, 58, 9363-9695; and Heck coupling is discussed in I. P. Beletskaya, A. V. Cheprakov, Chem. Rev. 2000, 100, 3009-3066. While discovery of this reaction dates back to over twenty five years, present interest is primarily associated with the development of the more potential and versatile catalysts. The use of highly active catalysts at low loadings not only minimizes the amount of palladium for reasons of cost but also offers advantages to put minimum efforts to obtain the products free from the catalyst. On attempting the Suzuki-Miyaura reaction with New Pd Catalyst, the inventors first conducted coupling of 4-bromo-2-methyl anisole with phenyl boronic acid using the catalyst and base in DMF. Heating the mixture at 110° C. for 5 h under N₂ followed by removal of New Pd Catalyst by filtration and chromatographic purification of the residue furnished the desired unsymmetrical biphenyl in 82% yield. High activity of the catalyst coupled with our interest in multi-couplings in one-pot reaction the inventors put their attention to evaluate the activity of New Pd Catalyst in one-pot sequential couplings of di- and tri-bromoarenes. Indeed, the inventors were able to prepare bis- and tris-coupled aryl benzenes in good to excellent yields, showing notable activity of the heterogeneous Pd-catalysts. In the case of 1,2-dibromobenzene, the inventors were previously unsuccessful in bis-couplings in one-pot reaction using Pd(OAc)₂ as the source of to palladium. The high activity of New Pd Catalyst made the coupling reactions successful thereby yielding the bis-product (ortho-terphenylene) in 55% yield. Similarly, 9,10-dibromoanthracene afforded the corresponding diphenylanthracene in 90% yield. The results are shown in Table 3.

Representative Procedure for Suzuki-Miyaura Reaction:

A mixture of 1,3-Dibromobenzene (236 mg 1.0 mmol), phenylboronic acid 271 mg (2.2 mmol) and sodium carbonate (424 mg, 4 mmol) was taken in DMF (2 ml) and then added New Pd Catalyst (300 mg, 2 mol % Pd) thereafter was 0.5 ml water added. The mixture was heated under nitrogen at 110° C. for 2.5 h. After cooling, the reaction mixture was diluted with 10 ml of cold water and filtered through a cotton bed. The filtrate was extracted with ether (3×30 ml) and the combined organic layer was dried over anhydrous Na₂SO₄. Removal of the solvent left a solid residue, which was purified by column chromatography on silica gel (light petroleum) to give m-terphenyl as color less solid (193 mg, 84% yield), m.p. 87-88° C. (Lit.³⁰ m. p. 89° C.); IR (Nujol): vₘₐₓ 1454, 1377 cm⁻¹; ¹H NMR (300 MHz, CDCl₃, 300K): δ=7.78 (s, 1H), 7.62-7.28 (m, 13H), ¹³C NMR (75 MHz, CDCl₃, δ=141.7, 141.1, 129.1, 128.7, 127.3, 127.20, 126.1.

TABLE 3
Suzuki-Miyaura coupling between aryl bromide and aryl boronic acid using New Pd-Catalyst.

| | | Conditions^{[a]} | | |
|---|---|---|---|---|
| Entry | Haoloaromatics | Temp./Time | Products | Yield [%]^{[b]} |
| 1. | 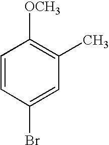 | 110° C./5h | 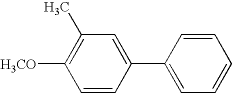 | 82 |
| 2. | 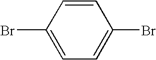 | 110° C./5h | 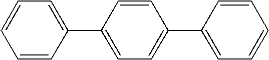 | 84 |
| 3. | 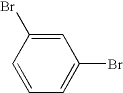 | 110° C./2.5h | 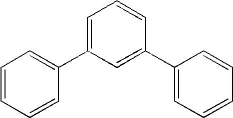 | 84 |
| 4. | 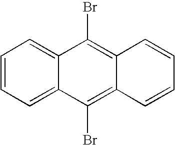 | 115° C./8h | 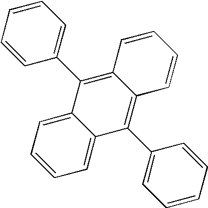 | 90 |
| 5. | 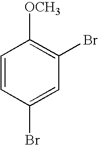 | 110° C./5h | 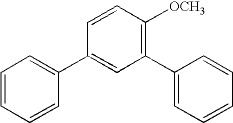 | 86 |
| 6. | 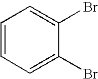 | 110° C./6h | 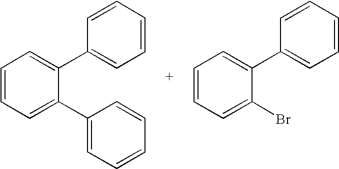 | 55 & 30 |
| 7. | 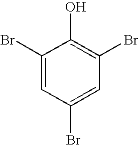 | 120° C./6h | 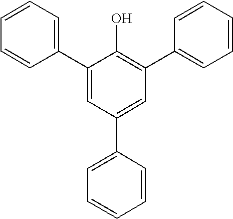 | 62 |

^{[a]}The reactions were carried out in DMF; New Pd-Catalyst (300 mg) was taken for 1 mmol of the bromoarenes.
^{[b]}Yields are of isolated products, characterized by m.p.; IR and NMR spectral data.

### EXAMPLE 9

### Buchwald-Hartwig (C—N) Coupling Reactions

Over the last decade, the Pd-catalyzed C—N coupling reactions, developed independently by Buchwald and Hartwig, has become a versatile tool for preparing aryl amines from aryl halides, triflates etc see J. P. Wolfe, S. Wagaw, J. F. Marcoux, S. L. Buchwald, Acc. Chem. Res. 1998, 31, 805-818 and J. F. Hartwig, Pure Appl. Chem. 1999, 71, 1417-1423. While employing similar coupling with halopyridines, Buchwald had experienced difficulty in achieving high yield of the product, possibly because of the formation of stable palladium complexes with pyridine. Such problem of trapping Pd out of the catalytic cycle was, however, circumvented by using chelating bis-phosphine ligands and the amination of bromopyridines was accomplished successfully with Pd₂dba₃-BINAP and other such catalytic combinations. Since aminopyridines are versatile intermediates as drugs and dyes, the inventors were interested to apply our resin-bound palladium catalyst in the amination of bromopyridines. Previously the inventors reported that KF/alumina could serve as a potential basic surface for amination reaction under solvent-free conditions. The inventors first examined coupling of 2-bromopyridine with pyrrolidine on KF/alumina surface in presence of the New Pd Catalyst. It was encouraging to observe completion of reaction by heating the reaction mixture at 95° C. for 2 h on KF/alumina surface. After the reaction, the solid mixture was simply placed over a column of silica gel to isolate the desired product in 90% yield. Similar reactions were performed with several dibromopyridines and amines using New Pd Catalyst as the catalyst. In all the cases studied, the inventors obtained the mono-aminated products selectively. It is significant that no ligands (phosphines) are required for the amination, a major feature for industrial applications. The results are summarized in Table 4.

Representative Procedure for Amination of Halopyridines:

2,5-Dibromopyridine (237 mg, 1 mmol) and 1 gm of KF/Al₂O₃^{[28]} were mixed under nitrogen, then New Pd Catalyst (300 mg, 2 mol % Pd) and 4-benzyl piperidine (486 mg, 3 mmol) were added to it. The final mixture was covered under N₂ and placed on pre-heated oil bath at 90° C. for 2.5 h. After cooling to room temperature, the solid mixture was transferred on a column of silica gel and elution with ethyl acetate/light petroleum (1:49) afforded 2-(4-benzylpiperidin-1-yl)-5-bromopyridine (291 mg, 88%); M.p. 78° C.; IR (Nujol): vₘₐₓ 1582, 1543, 1472 cm⁻¹; ¹H NMR (300 MHz, CDCl₃, 300K): δ=8.16 (d, 1H, J=2.4 Hz), 7.47 (dd, 1H, J=9 & 2.4 Hz), 7.31-7.13 (m, 5H), 6.51(d, 1H, J=9 Hz), 4.22-4.18 (m, 2H), 2.80-2.70 (m, 2H), 2.55 (d, 2H, J=6.9 Hz), 1.82-1.69 (m, 3H), 1.31-1.81 (m, 2H). ¹³C NMR (75 MHz, CDCl₃, 300K) δ=157.9, 148.4, 140.2, 139.6, 129.1, 128.2, 125.9, 108.5, 106.7, 45.7, 43.1, 38.2, 31.6.

TABLE 4
Buchwald-Hartwig amination of bromopyridines with sec. amines using New Pd-Catalyst.

| | | | Conditions^{[a]} | | |
|---|---|---|---|---|---|
| Entry | Halopyridine | Amine | Temp./Time | Products | Yield [%]^{[b]} |
| 1 | 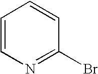 | 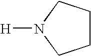 | 95° C./2h | 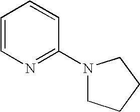 | 90 |
| 2 | 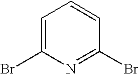 | 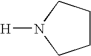 | 90° C./1h | 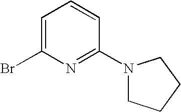 | 86 |
| 3 | 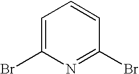 | 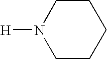 | 80° C./2h | 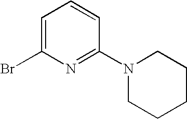 | 77 |
| 4 | 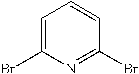 | 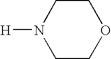 | 90° C./1h | 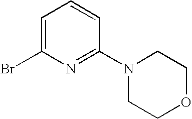 | 79 |
| 5 | 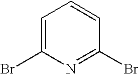 | 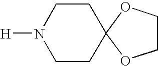 | 80° C./2.5h | 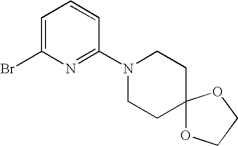 | 81 |
| 6 | 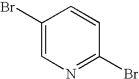 | 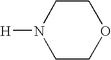 | 90° C./2h | 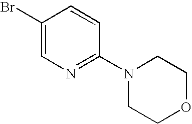 | 86 |
| 7 | 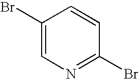 | 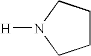 | 80° C./2h | 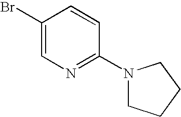 | 92 |
| 8 | 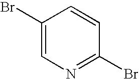 | 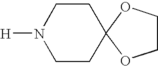 | 90° C./3h | 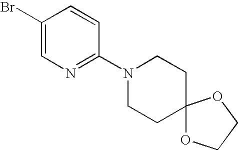 | 84 |
| 9 | 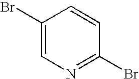 | 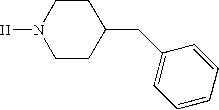 | 90° C./2.5h | 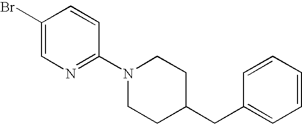 | 88 |

^{[a]}The reactions were carried out using KF/alumina and without any solvent; New Pd-Catalyst (300 mg) per mmol of bromopyridine.
^{[b]}Yield of isolated products, characterized by m.p., IR and NMR spectral data.

### EXAMPLE 10

### Minimum Concentration of Palladium on the Surface Required for Efficient Catalytic Activity

In order to find the minimum atomic concentration of palladium that is required to exhibit efficient catalytic activity, the inventors chose the Suzuki-Miyaura coupling reaction as the model case. Different amounts of palladium acetate (1-10 mg) per 1 g of the ARF were used to immobilize palladium under various conditions and the resulting New Pd Catalyst was used in the Suzuki-Miyaura coupling of 1,4-dibromobenzene with phenylboronic acid. Loading of palladium from Pd(OAc)₂ used up to 5 mg for 1 g of ARF seemed to decrease the catalytic efficiency in the second run of Suzuki-Miyaura coupling. Repeating the process of immobilization at different temperatures did not result any significant enhancement in catalytic activity. In fact, immobilization of palladium using either 10 mg of Pd(OAc)₂ for 1 g of ARF at 50° C. for 3 h did show excellent catalytic activity even up to the fifth run with the formation of the coupled product in 80-84% yields. While probing the leaching of palladium from New Pd Catalyst, it appeared from ICP-OES studies to be a relative steady amount of palladium to leach out during every synthesis.

The minimum effective concentration of Pd in the surface of the resin was established as the use of 7.5 mg of Pd(OAc)₂ for 1 g of the ARF and prepared at 50° C. for 3 h in DMF followed by treatment of the New Pd Catalyst in DMF at 100° C. for 2 h.

TABLE 5
Minimum concentration of Palladium from Pd(OAc)₂

| | | | | % Yield in |
|---|---|---|---|---|
| | | | | Suzuki - |
| | | | Temp./Time/ | Miyaura coupling |
| Entry | Pd(OAc)₂ | ARF | Conditions^{[a]} | product^{[b]} |
| 1. | 10.0 mg | 1 g | 1 h at rt and then | 84% (1^{st} Run) |
| | | | 50° C./3 h | 84% (2^{nd} Run) |
| | | | | 81% (3^{rd} Run) |
| | | | | 80% (4^{th} Run) |
| | | | | 80% (5^{th} Run) |
| 2.^{[c]} | 7.5 mg | 1 g | 1 h at rt and then | 83% (1^{st} Run) |
| | | | 50° C./3 h, | 81% (2^{nd} Run) |
| | | | then filtered, washed | 78% (3^{rd} Run) |
| | | | and dried. Again taken | |
| | | | in DMF, heated at 100° C. | |
| | | | for 2 h, and filtered, | |
| | | | washed and dried. | |
| | | | And used in Suzuki | |
| | | | Coupling reaction | |
| 3. | 5 mg | 1 g | 1 h at rt and | 78% (1^{st} Run) |
| | | | 50° C./2 h | 50% (2^{nd} Run) |
| 4.^{[c]} | 5 mg | 1 g | 1 h at rt and | 78% (1^{st} Run) |
| | | | 70° C./2 h | 35% (2^{nd} Run) |
| 5. | 2.5 mg | 1 g | 1 h at rt and | 76% (1^{st} Run) |
| | | | 50° C./2 h | 46% (2^{nd} Run) |
| 6.^{[d]} | 2.5 mg | 1 g | 1 h at rt and | 76% (1^{st} Run) |
| | | | 50° C./2 h, then | 46% (2^{nd} Run) |
| | | | filtered and dried. | |
| | | | Again takenin DMF, | |
| | | | heated at 100° C. for | |
| | | | 1 h, filtered and dried. | |
| 7. | 1.0 mg | 1 g | 1 h at rt and | <5% (1^{st} Run) |
| | | | 50° C./2 h, | |

^{[a]}Occasional shaking the suspension of ARF and Pd(OAc)2 in DMF and water.
^{[b]}SM reaction was studied between the coupling partners: 1,4-dibromobenzene (1 mmol) and phenylboronic acid (2.5 mmol).
^{[c]}To observe any change in catalytic activity when immobilization is performed at higher temperature.
^{[d]}To examine any leaching of Pd before applying in reaction.

### EXAMPLE 11

### Recycle Experiments and Leaching of Palladium

Recycle experiments were also verified taking the Suzuki-Miyaura couplings between 1,4-dibromobenzene and phenylboronic acid. After the reaction, the catalyst (New Pd Catalyst) was filtered off, washed with dichloromethane, water and finally dried under vacuum for further use. Consecutive five runs were tested to evaluate the activity of New Pd Catalyst that was prepared from 10 mg of Pd(OAc)₂ for 1 g ARF (Table 5, Entry 1). The New Pd Catalyst prepared from 7.5 mg of Pd(OAc)₂ for 1 g ARF (Table 5, Entry 2) was also tested for three run with almost equal efficiency. The results are presented in Table 6, which show that the catalyst is remarkably active even in the fifth run/third run and thus the coupled product, p-terphenylene, was isolated without any significant drop of yields.

TABLE 6
Recycling Experiments in
Suzuki-Miyaura Couplings using New Pd-Catalyst.

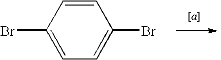

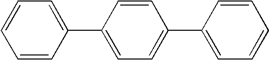

| Run | 1 | 2 | 3 | 4 | 5 |
|---|---|---|---|---|---|
| Yield [%] | 84 (83)^{[b]} | 84 (81) | 81 (78) | 80 | 80 |
| Time [h] | 5 | 5 | 5 | 5 | 5 |

^{[a]}Reagents & Conditions: 1,4-Dibromobenzene (2 mmol), Phenylboronic acid (4.5 mmol), New Pd-Catalyst* = 600 mg, DMF (4 mL), 110° C.
*New Pd-Catalyst prepared from 10 mg of Pd (OAc)₂for 1 g ARF (Entry 1, Table 5).
^{[b]}Yields in the parenthesis represent use of New Pd-Catalyst prepared from 7.5 mg of Pd (OAc)₂ for 1 g ARF (Entry 2, Table 5).

Leaching of palladium should generally depend on the nature of solvent used for a reaction. Although there is evidence that toluene as the solvent could prevent leaching of palladium, the poor solubility of the coupling partners and the extrinsic base (Na₂CO₃) in toluene might result in poor yield of the product. The inventors therefore carried out the Suzuki-Miyaura couplings between 1,4-dibromobenzene and phenylboronic acid in DMF and water as the solvent. The reaction was repeated using the recovered New Pd Catalyst and its palladium content was measured with ICP-OES. The leaching of palladium was followed both by measuring Pd content of New Pd Catalyst (FIG. 8) after synthesis and by measuring Pd concentration in the solvent after reaction (FIG. 7). These measurements indicated that there is a low but steady leaching of palladium from the catalyst. This was not the case when ARF-Pd resins were used which is a gel type (Dowex SBR 500, Dowex SBR LCNG both equivalent with Amberlite IRA 420).

Although the mechanism of involving Pd⁽⁰⁾ species is generally accepted in homogeneously catalyzed coupling reactions, such thought for heterogeneous catalysts still remains under consideration. The surface bound Pd⁽⁰⁾ is the active species, analogous to homogeneously catalyzed coupling reactions, which undergoes oxidative addition to aryl C-halogen bonds. As observed in XPS studies of New Pd Catalyst., the Pd spectra suggests the presence of both Pd⁽⁰⁾ and Pd^{(II)} species at the polymer surface. At this stage, the inventors propose that the Pd⁽⁰⁾ is the active species, having soaked at the resin surface possibly through reduction of Pd^{(II)} salts by the carboxylate functions (formate).

In summary, the inventors have demonstrated for the first time that suitably designed ion-exchange resins can be used as the potential polymeric surface to scavenge and immobilize palladium metal and the resulting palladium-soaked ionic resins can be used as efficient heterogeneous catalyst. The major advantage of using the formate as the counter anion is to facilitate reduction of Pd(II) to Pd(0) in situ followed by deposition on the surface. The heterogeneous Pd-catalyst exhibits high catalytic efficiency in Heck, Suzuki-Miyaura, Sonogashira coupling (C—C bond-forming) and Buchwald-Hartwig (C—N bond-forming) reactions. The phosphane or ligand-free reaction conditions could be of potential interests for commercial applications of heterogeneous catalyst in C—C and C—N coupling reactions. Strict compliance with absence of air or moisture is not required and easy separation of the catalyst, isolation of the products in good to excellent yields and reuse of the New Pd Catalyst for at least five runs are attractive facets for the heterogeneous catalyst. The resin soaked catalyst can be stored for several weeks without any special protective arrangements like under-argon atmosphere or low temperatures.

### EXAMPLE 12

Sonogashira coupling

| Iodoarene | Acetylene | Conditions | Product | Yield |
|---|---|---|---|---|
| 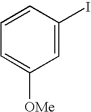 | 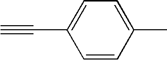 | Et₃N (2 Eq)/ 80° C./6h | 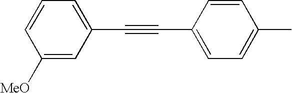 | 87% |
| 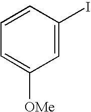 | 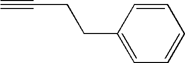 | Et₃N (2 Eq)/ 80° C./6h | 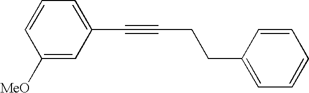 | 81% |
| 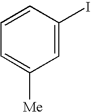 | 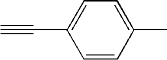 | Et₃N (2 Eq)/ 80° C./4h | 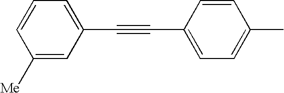 | 96% |
| 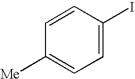 | 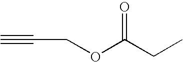 | Pyridine (2 Eq)/ 80° C./9h | 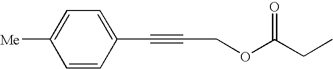 | 95% |

300 mg of New Pd Catalyst was used for 1 mmol of iodoarene. Acetylene was used in 1.2 equiv. All reactions were carried out in CH₃CN (solvent) and yields are obtained after chromatographic separation. Recycling of the New Pd Catalyst has not been tested yet. The reactions are clean and no other products are detected on TLC plate. In first three cases Et₃N was found to be better than pyridine as the base.

1. A method of producing a heterogeneous catalyst suitable for catalyzing Heck, Suzuki-Miyaura, Sonogashira coupling and Buchwald-Hartwig reactions, comprising the steps of:
a) providing a macroporous carrier, said macroporous carrier comprising a core and a plurality of ion exchange groups covalently bonded to the surface of said core, where at least 90% of the ions bound to said carrier are formate ions;
b) swelling said carrier in a polar solvent;
c) providing a palladium (II) salt;
d) suspending said carrier in an organic solvent thereby obtaining a suspension;
e) adding said palladium salt to said suspension and allowing the resulting mixture to react at a temperature within the range of 0-70° C. until said carrier has turned black;
f) washing said carrier in water; and
g) drying said carrier under vacuum.

2. The method according to claim 1, wherein step b) is performed using a polar solvent selected from the group consisting of methanol and methanol.

3. The method according to claim 1, wherein the resulting carrier after step g) is allowed to catalyse a chemical reaction chosen from the group of Heck, Suzuki-Miyaura and Buchwald-Hartwig reactions.

4. The method according to claim 1, wherein the carrier has the shape of spherical particles having a size ranging from 10 μm to 2 mm and a porosity from 50 to 1000 Å, or a monolithic structure.

5. The method according to claim 1, wherein the core of said carrier is made of a material chosen from the group consisting of porous silica, zirconium, graphite, and a polymer or copolymer chosen from the group consisting of mono- or oligovinyl monomer units, such as styrene and its substituted derivatives, acrylic acid or methacrylic acid, alkyl acrylates and methacrylates, hydroxyalkyl acrylates and methacrylates, acrylamides and methacrylamides, vinylpyridine and its substituted derivatives, divinylbenzene, divinylpyridine, alkylene diacrylate, alkylene dimethacrylate, oligoethylene glycol diacrylate and oligoethylene glycol dimethacrylate with up to 5 ethylene glycol repeat units, alkylene bis(acrylamides), piperidine bis(acrylamide), trimethylolpropane triacrylate, trimethylolpropane trimethacrylate, pentaerythriol triacrylate and tetraacrylate, and mixtures thereof.

6. The method according to claim 5, wherein the carrier is an Amberlite ion exchange bead.

7. The method according to claim 1, wherein ion-exchange groups are introduced on the surface of said carrier before step c) by functionalizing via a chemical reaction.

8. The method according to claim 7, wherein the ion-exchange groups have been introduced to the carrier by polymerizing monomers comprising ion-exchange groups onto the surface of the carrier core.

9. The method according to claim 8, wherein the ion-exchange groups are a type 1 or a type 2 quaternary ammonium group.

10. The method according to claim 1, wherein at least 95% of the ions bound to the carrier are formate ions.

11. The method according to claim 1, wherein said palladium (II) salt is chosen from the group consisting of palladium acetate (Pd(CH₃COO)₂) and disodium palladium tetrachloride (Na₂PdCl₄).

12. The method according to claim 1, wherein said organic solvent in step d) is chosen from the group consisting of dimethyl formamide (DMF), acetonitrile, toluene and dioxane.

13. The method according to claim 1, wherein the resulting mixture is allowed to react at a temperature within the range of 40-60° C.

14. The method according to claim 1, wherein the polar solvent used in the final washing is chosen from the group consisting of dimethyl formamide, water dichloromethane, acetone, diethyl ether, tetrahydrofuran and dioxane.

15. A heterogeneous catalyst comprising a porous carrier consisting of a core and a plurality of ion exchange groups covalently bonded to the surface of said core on which surface Pd (0) as well as a formate anion has been deposited, wherein the catalyst has been produced by a method according to claim 1.

16. A reactor comprising a hollow tube, said tube having two open ends, wherein the reactor a heterogeneous catalyst according to claim 15.

17. (canceled)

18. The method of claim 2, wherein the polar solvent is methanol.

19. The method of claim 4, wherein the size of the spherical particles is 420 urn or greater.

20. The method of claim 8, wherein the polymerizing is graft-polymerizing.

21. The method of claim 10, wherein at least 99% of the ions bound to the carriers are formate ions.

22. The method of claim 13, wherein the resulting mixture is allowed to react at a temperature within the range of 45-55° C.
